(19) United States
(12) Patent Application Publication
(10) Pub. No.: US 2018/0320518 A1
(43) Pub. Date: Nov. 8, 2018

(54) Solid-liquid phase change driven heat engine via hydraulic oil power generation

(71) Applicant: Yanming Wei, Mountain (CA)

(72) Inventor: Yanming Wei, Mountain (CA)

(21) Appl. No.: 16/021,000

(22) Filed: Jun. 27, 2018

(51) Int. Cl. F01B 7/16; F01B 23/02; F03G 7/06; F01B 23/08

(52) U.S. Cl. CPC F01B 7/16; F01B 23/08; F03G 7/06; F01B 23/02

(57) ABSTRACT

A new kind of solid-liquid-solid cyclic phase change heat engine is presented with optional but highly recommended multiple cylinders aka multiple stages cascading powertrain. Unlike the traditional Rankine engine or Stirling engine, hereby the gaseous phase is prohibited, and the conventional turbine is abandoned too. Under the drive of heat flux, low expansion volume of the working Phase Change Material (PCM) replaces the high expansion volume of hot gas, and in compensation, high expansion pressure replaces the low expansion pressure of hot gas. Via the isolated transformation from PCM pressure to hydraulic oil pressure, plus fluidic AC-DC rectification, a standard hydraulic motor replaces the gas or steam turbine. Multi-cylinder cascading heat engine can linearly increase up efficiency close to the ideal Carnot efficiency. With this invention, heat-rechargeable melting salt thermal storage can efficiently power vehicles with competitive lightweight of thermo pack at middle temperature, challenging those fuel cell or lithium battery powered vehicles.

### BACKGROUND AND PRIOR ARTS

Until nowadays, all heat engines are based on either liquid-gas-liquid thermodynamic circle, such as the most common Rankine type, or the gas-gas-gas circle, say, a Stirling engine.

Why nobody dares to invent a solid-liquid-solid circle heat engine? Of course, everyone knows that only gas can render a decent large expansion for mechanic work.

It is an obvious fact that a steel pipe can easily burst if not insulated in deep cold winter. Experiments show that even a container with 1″ thick wall can crack when fully filled with water and let ice form inside. The phenomena prove that the expansion pressure is far greater than any gas expansion, and the pressure can soar to an astonishing 3000+ atm (atmosphere), though its volume change is insignificant (10%) while phase changes occur at about 0° C.

By retarding the phase change transition, power can be harnessed for output undoubtedly. Therefore, I am going to be the pioneer, and hereby present a disruptive innovation on the Solid-Liquid phase change Heat Engine (SLHE).

As the pressure surpasses about at least one order of magnitude than gas expansion, and falls in or even exceeds the range of commercial hydraulic pressure, therefore my inventions no longer use the conventional gas or steam turbines, but conveniently utilize those proper hydraulic motors that are ready made available in markets.

The higher the pressure, the greater the power density, thus, roughly speaking, the SLHE will weigh lighter by one order of magnitude, and occupy lesser space by two orders of magnitude than the traditional Rankine engines or Stirling engines.

Typically, the specific power density of a steam turbine is about 0.5 kw/kg, and power density 0.3 Mw/m³, and in contrast, for typical hydraulic motor, 5 kw/kg, 30 Mw/m³ respectively. From catalogues of typical manufacturers Alstom and Bosch, those data can be coarsely estimated.

When dealing with an abstract turbine or expander of heat engine, application designers often feel lost and are in rather a spin about clueless choices—the likes of one with mazy numerous blades as in a steam turbine, or one with simple auger enveloped by shell in profile of recondite mathematic asymptote, or else? Any of those choices will probably need a customization manufacture. In contrast, for a hydraulic motor, luckily just go to market and find a proper one.

An ideal solid-liquid PCM (Phase Change Material) will keep temperature constant during phase change at condition of STP (Standard Temperature & Pressure). However if pressure retarded, then melting point will increase for most PCM, except fewer materials, such as water.

Anyway, the melting point change is just minor, and thanks to this property, it enables the possibility to make efficient use of abundant waste heat for power generation with lower temperature differential.

In thermodynamic theory, the Carnot efficiency has jailed all worldly heat engines. However the SLHE seem not to be mentioned in any textbook. It leaves imagination space for Carnot efficiency jailbreak.

With proper design & engineering, the SLHE heat engine can run more efficient than those so-called organic Rankine heat engines, as well as very lower manufacture cost.

As the hydraulic circuit of powertrain is identical to the one that was described in my previous invention: “Osmosis energy storage & restoration system and indirect solar powerplant” which original patent application is U.S. Ser. No. 15/902,651, hence, some drawings will be borrowed from there for convenience description.

### SUMMARY OF THE INVENTION

In subject inventions, a solid-liquid phase change heat engine comprises 4 main components: the pressure transformer, the AC-DC fluid rectifier, the hydraulic motor, and the central logical controller that coordinates systematic operation.

PCM renders huge expansion pressure but small volume change, and only 50% of duty cycle is of flowable in liquid phase, but the other 50% of duty cycle unable or hard to flow in solid phase.

To harness such special raw energy, a pressure transformer is imperative, so as to transmit the raw energy to other medium, e.g. hydraulic oil that is flowable in 100% of duty cycle, as well as to isolatedly condition the output pressure.

After PCM changed its phase and did expansion work, it is not supposed to be dumped as waste, but should restore previous shrinking phase, despite idle or no work harvestable during the phase restoration, however it will be ready for next repeating duty.

With a pair of same working PCM loaded in conjugate chambers of pressure transformer, under the scheduling of the central logic controller, one side PCM can be switched to do expansion work while the counterpart side PCM idles in shrinking process.

Another pair of conjugate hydraulic oil chambers should be coupled with the pair of working PCM chambers to sustainably harvest the reciprocal powerful work transmission.

All in all, it is the heat flux driving energy that enables phase change and power transmission, and all working PCM must interface with heat reservoirs of both source and sinker, but only one reservoir can send or receive heat through the respective PCM at a time slot.

A working PCM can host either one immersible or soaked heat exchanger or two.

But if only one shared heat exchanger, then when switch it from heat source to sinker, its internal heat flux direction will change, and because of thermal inertia of vessel metal, the residual heat will fleetingly counteract at the very beginning, then go normal, unless there is a reasonable pause before switching. Minor bits of thermal conducting liquid of different reservoirs will risk of mixing, and it is undesirable.

The other choice with two heat exchangers enables a PCM to separately hook heat source and sinker with 2 independent circuits. It eliminates those negative effects of heat inertia and liquid mixing. Therefore, it is preferable to co-immerse two heat exchangers in every working PCM.

A pressure transformer is supposed to report its ram or axle or shaft position by proper sensor(s) to the central logic controller, so as to be accurately managed in real time.

Actuation of switching heat reservoirs for working PCM is usually executed by electromagnetic valves and/or circulation pumps via the central logic controller, and the auxiliary power is provided by a battery that can be recharged after the engine startup.

In a sense, a pressure transformer resembles a common AC electrical transformer with primary and secondary coils winding around silicon steel core, but the former deals with fluids and the latter with electrons. In addition, minor power is needed to guide inversion from pristine DC “current” of PCM during phase change to AC fluid current, because there is no DC transformer even in electrical domain.

As a common sense, an electrical motor that can be made with either AC or DC driver in acceptable discrepancy of cost, but in fluid mechanics, only DC hydraulic motor can be economically manufactured. Therefore, the secondary AC output of a pressure transformer must be rectified to DC oil current, so as to drive a common hydraulic motor.

To stabilize the hydraulic output, a hydraulic accumulator is needed with enough capacity, and a hydraulic tank is better to be equipped for oil buffering and service convenience.

If the eventual power demand is only mechanic, e.g. for driving a car, then an small auxiliary electricity generator can be coupled to the shaft of hydraulic motor, so as to recharge the inline auxiliary rechargeable battery and to supply the central logic controller; otherwise a commensurate electricity generator should be equipped for eventual electric power supply.

Usually exotic SLHE prefer those stable heat reservoirs, but have not to be limited to, thus a large PCM aggregates based energy storage is a good choice for heat source.

All components are supposed to be insulated if their working temperature is significantly different with ambient atmosphere. Reducing thermal loss can benefit efficiency enhancement.

If heat reservoir's temperature is equal or close to weather, then insulation is not necessary and the storage-purposed PCM is unnecessary too, unless in favor of the married heat pump.

The melting point of working PCM inside the pressure transformer usually takes the mean temperature value of the heat source and sinker, so as to enable same length of transient time during PCM expansion & contraction.

As per many experiments, the SLHE's efficiency is most likely under 10%. Therefore a bold invention is innovated by multiple cylinders cascading SLHE, and let both the hydraulic motor and central logic controller be shared in the ensemble, so as to increase efficiency to a sum-up total and let the eventual efficiency be closer to ideal Carnot efficiency.

In this serial powertrain mode, the heat sinker of previous SLHE unit becomes the heat source of next one, and the grand temperature drop between the topmost heat reservoir and bottommost one, is usually divided in equal working temperature drop for all constituent units.

As to the intermediate reservoirs of multi-cylinder SLHE, lean or less mass PCM can be workable, because those nodes need not store substantial thermal energy but simply relay the transient thermal flux.

Therefore, considering the linear increase of efficiency, the cost of multi-cylinder SLHE is quite economic, because cylinders plus working PCM are not worth much, even by big multiplication, and the expensive storage-purposed PCM aggregates can have almost same amount with the single-cylinder SLHE.

With this great innovation, many potential applications can be explored, such as cryogenic heat engine in synergy with liquid air energy storage, clean thermal battery for vehicle, electricity generator driven by low grade heat in NetZero building system, and etc.

### DETAIL DESCRIPTION ON ALL DRAWINGS, POSSIBLE EMBODIMENTS & RELEVANT ANALYSIS

Description on FIG. 1

FIG. 1 shows the closeup view of interface between PCM and hydraulic oil. Consisted of a middle oil cylinder and 2 end PCM cylinders with all pistons aligned in a line, it can also be described as pressure transformer, which primary power inputs by heat conversion, and secondary power outputs to outside load (e.g. hydraulic motor) in the oil circuit.

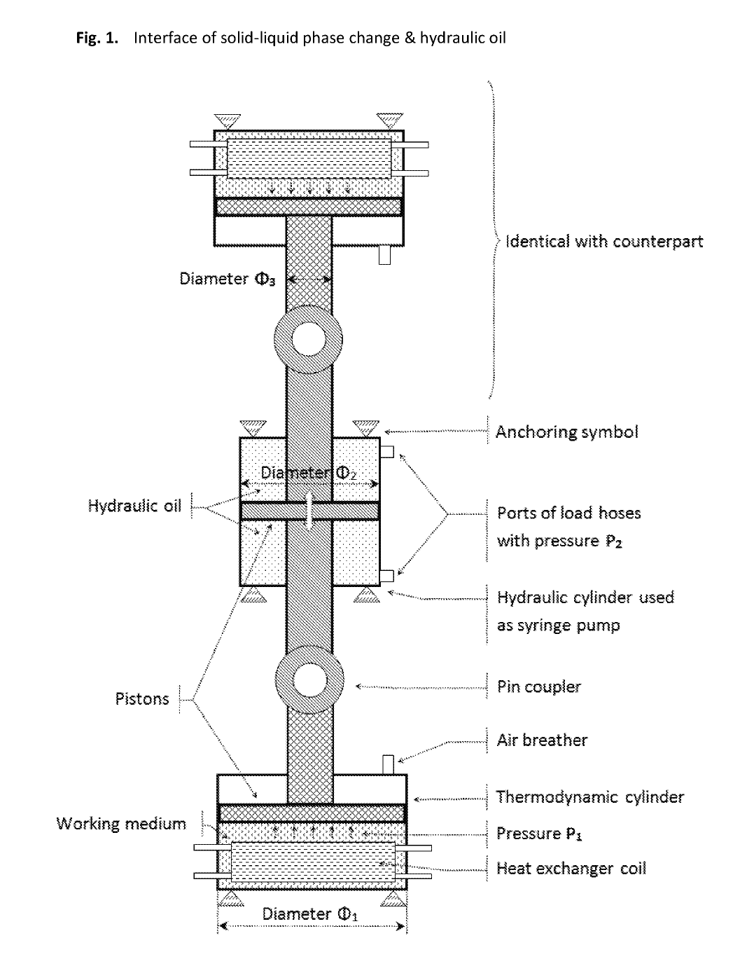

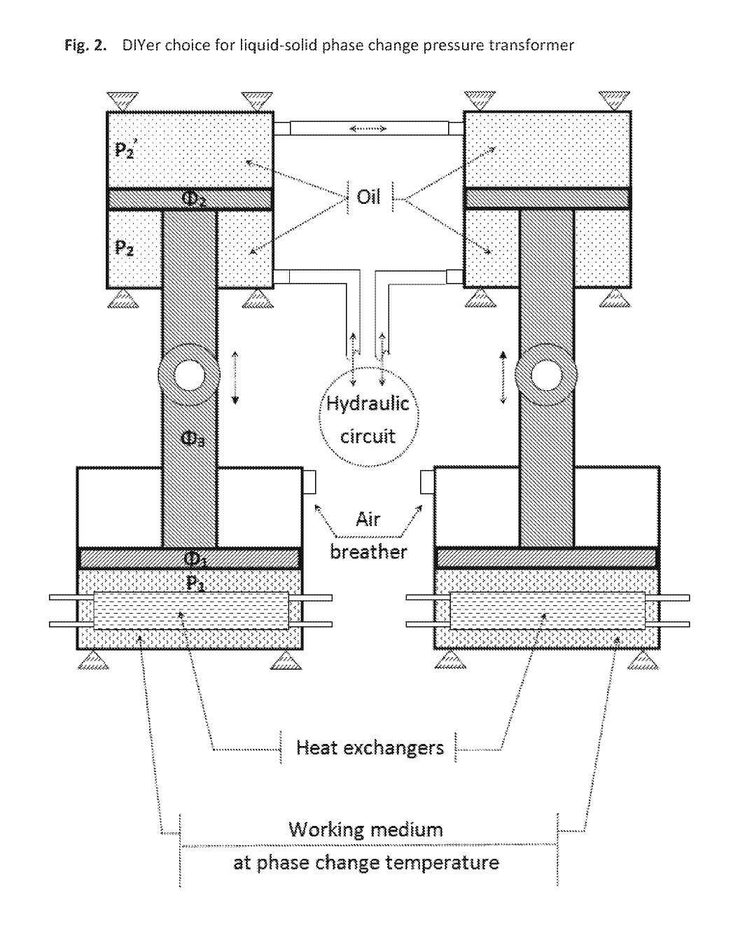

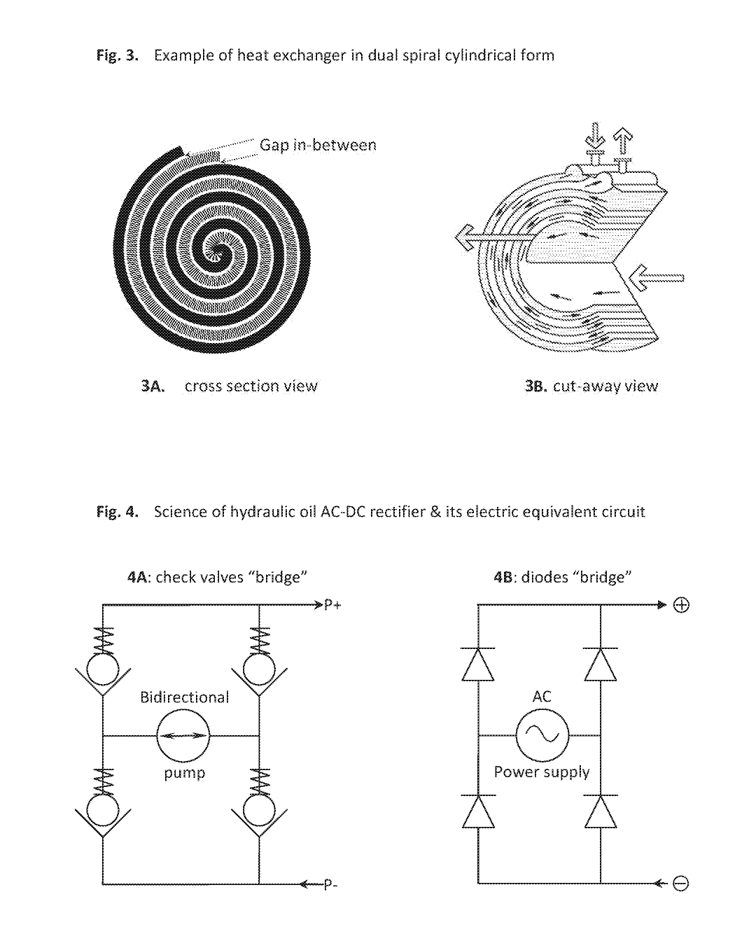

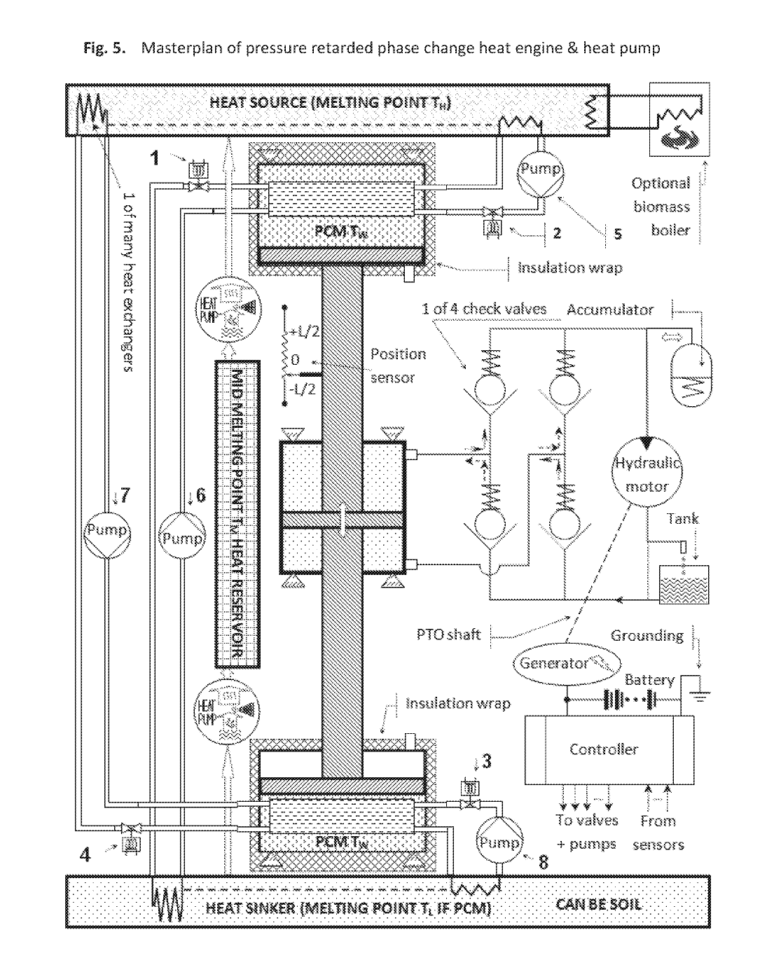

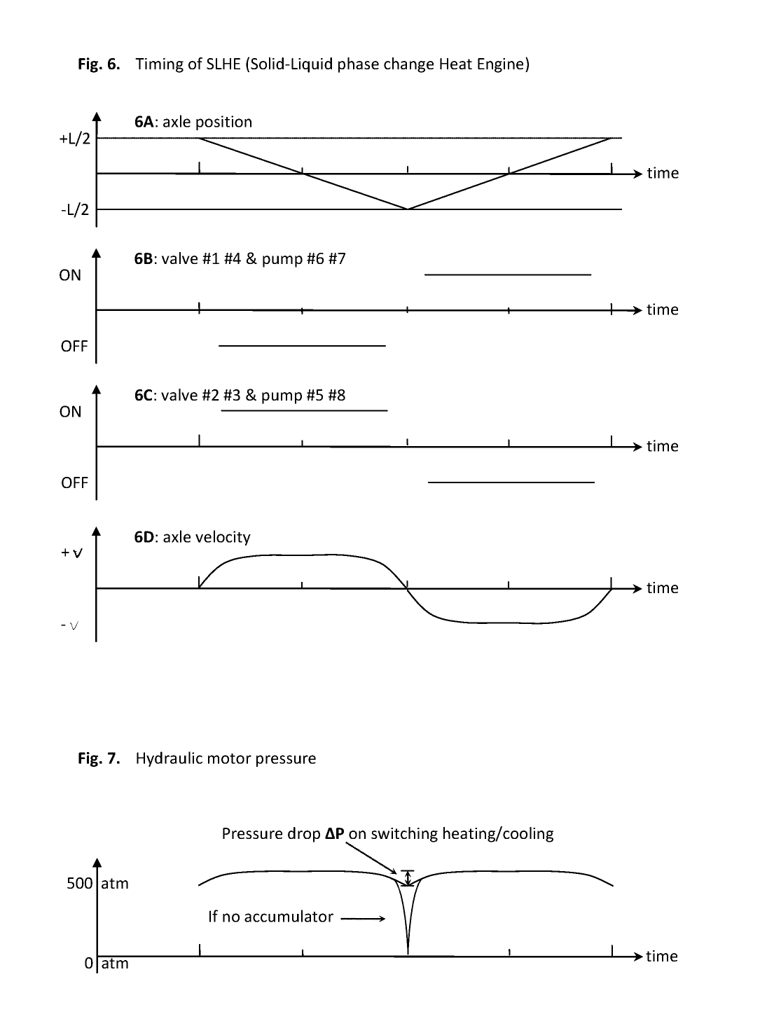

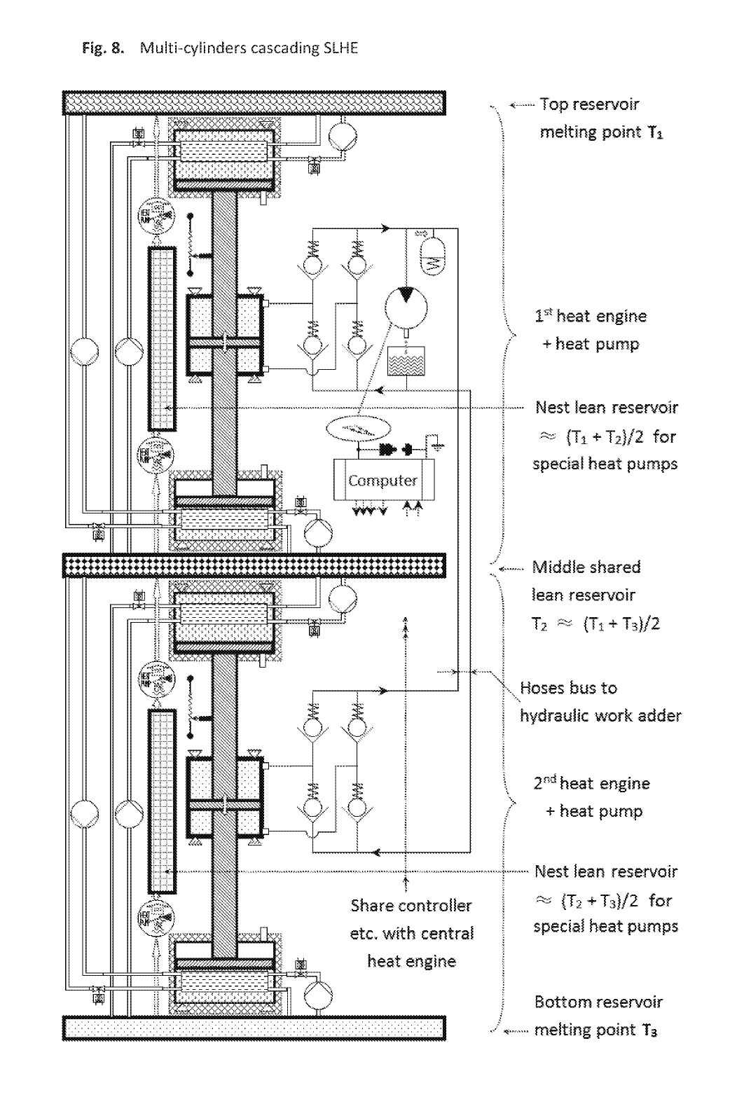

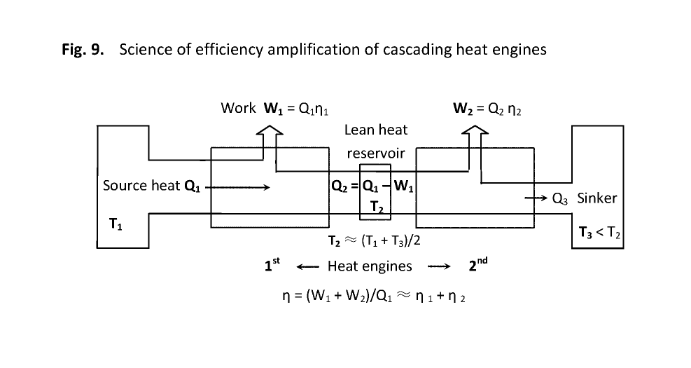

It is purposed to only emphasize on the mutual isolation between hydraulic oil and PCM, not restrict how to realize isolation or how far between their holding compartments. As to embodiment forms, there are many possible, this figure just illustrates the all-through axle style.

In this figure, each PCM is drawn in v-spangled area and oil is drawn in dotted area; anchoring points are drawn in the shaded triangle symbol; each heat exchanger is drawn in block of dash lines with inlet or outlet ports, furthermore each pair of ports denotes the tube open ends of an internal vessel; all major elements are marked by callout labels, and some important elements will be described in more detail hereafter if necessary.

The important heat exchangers control how the surrounding PCM to solidify or liquefy by circulating cool liquid at temperature of heat sinker or hot liquid at temperature of heat source.

In the PCM chamber, every heat exchanger is supposed to cram most of PCM minimal space for quick heat transfer and reduction of thermal inertia.

The PCM can only render small volume change, most likely fewer than 10%, but minor may up to 20%. Therefore, the heat transfer efficiency seems invariable between 2 processes of solidification and liquefaction, though efficiency may unnoticeably decrease a little bit during PCM expansion, because the rigid heat exchanger is not synchronously expandable at same rate to serve the expanded volume.

By the way, in contrast, the volume may change tens to thousands multiple for liquid to gas phase change or expansion of overheated gas in conventional heat engine.

The heat exchangers do not have to be built with a pair of isolated tube-ways or vessels for separate hot and cool fluidic circulation. Although not recommended, even one heat exchanger can still cope with application, just let hot and cool heat transfer fluids share one vessel in different time slots, as per the logic control on demand of melting or condensing.

Although the hydraulic cylinder & PCM are drawn as different components & coupled by a pin, however, it may be only good for DIYers but manufacturers may prefer to fabricate them as a whole unit for massive production.

For better thermal insulation between different chambers, insulation spacers and socks can be inserted at those pinned joints. This is another advantage of pins.

The cylinder with PCM chamber cannot use regular hydraulic cylinder with only oil orifice(s) for hose fittings, because the solid heat exchanger cannot be stuffed inside. Hence, customization is needed with a wide removable leakproof end cap.

The piston diameter of PCM chamber is marked as ϕ₁, hydraulic piston as ϕ₂; axle as ϕ₃; the PCM phase change pressure is P₁, oil pressure P₂. There is equation for above 5 parameters:

P₁*πϕ₁²=P₂*π(ϕ₂²−ϕ₃²)

Obviously if ϕ₁>ϕ₂ then oil pressure will be greater than phase change pressure, vice versa, that is why it is named as pressure transformer. Therefore it is possible to pre-design working states for PCM & oil sides to enable both in best performance.

For example, if water is used as PCM, then the icing expansion pressure 300 MPa is 10× the rated pressure for commercial hydraulic products, thus there should be ϕ₂²≈10*ϕ₁²+ϕ₃².

During the heating or cooling process of PCM, the pushed oil side will send powerful oil current to the connected hydraulic hose, so as to do work in loads; meanwhile, oil in the opposite side of hydraulic piston will appear vacuum state, so as to suck inward the return oil from load's exhaust port or oil tank with air breather.

Despite that minor leakage may occur around rim of PCM chamber while solid to liquid transition if PCM fluid viscosity not ideal, anyway, it is still tolerable and worthy, as long as the leakage is insignificant enough, e.g. <1% of PCM volume per day. Especially there may be zero loss of power & mass, if the working PCM is selected from those abnormal likes of water which liquefaction shrinks and solidification expands, because only expansion is supposed to do work and there is almost no leakage for the pressure retarded solid medium.

Most PCM materials are the normal likes which liquefaction expands and solidification shrinks, however, either normal or abnormal PCM can be used in the SLHE, and the only difference is how to control the connection switching logics for the embedded heat exchanger with heat source & heat sinker.

Because phase change pressure is usually as huge as hydraulic pressure, therefore, pipe thickness of all heat exchangers must reasonably be thick. Luckily all pipes or vessels in heat exchangers of pressure exchangers are fully filled with uncompressible liquid, so the thickness shall be moderate, though still far thicker than those applied in regular low pressure environment.

Although the square or other non-circle shape is not prohibited for the cross section of PCM hosting cylinders, however the circle shape is almost the only choice.

Last but not least, it is a good practice to keep proper distance between 2 PCM chambers, because neighboring too close even contact will result in their unwanted mutual heat transfer, though there exists a possible configuration, which uses the middle cylinder to host 2 PCM chambers at both sides of the piston, and deploys 2 single acting hydraulic cylinders at both ends of the main axle.

Description on FIG. 2

FIG. 2 shows another DIY-able configuration of PCM to oil pressure transformer.

In principle, this design is identical to the previous, just in different style with dual-axle. It comprises two symmetric halves. A pair of regular cylinders is used for hydraulic oil power transmission, and another pair of customized cylinders is used for PCM heat-power conversion.

DIYers may love this alternative design, as herein hydraulic cylinders are more popular & procurable than those in previous figure.

Usually the 2 halves are parallel by respective reciprocal axles, and proper orientation may take advantage of gravity if the PCM has minor leakage and needs neat shedding.

The oil pressures across the piston are different, P₂′<P₂, because of different contact surface area. Although undrawn in the subject figure, but if the 2 lower oil orifices are short-connected, and the 2 uppers are used to drive hydraulic motor, then the ratio of output oil pressure to PCM expansion pressure will obviously not affected by the diameter of axle of pistons.

Filling the oil chambers may need a whit of trick & patience, especially for the 2 oil chambers that are directly connected by a hydraulic hose, and the key process is to carefully swap out air.

Just like as the previous figure, air breathers are drawn in the PCM cylinders. By taking advantage of ample drawing space in this figure, though somewhat wordy, a descriptive label is used to emphasize that PCM shall work around the phase change temperature, which will appear small fluctuation when pressure retarded.

However, the alternating hot or cool fluids in respective tubing circuits of heat exchangers shall render temperature at far away than the PCM, so as to quicken heat transfer. For example, if the PCM is water, then hot fluid better above +30° C., and cool fluid better below −30° C. This empirical rule applies to all different designs of PCM to oil pressure transformers.

Description on FIG. 3

FIG. 3 shows a sample of heat exchanger with cylindrical spirally interleaved dual vessels. It contains 2 sub-figures rendering the views from different angles.

Among all heat exchanger designs, this one seems excellent in performance of heat transfer, as either hot or cool fluid conveying vessel can contact the environing PCM with surface area at max extent. After deployed in a PCM chamber, it seems to occupy most volume.

Similar basic structure is also mentioned in many publications where only 2 media exchange their heat in the twined vessels, and obviously the 2 vessels fully contact each other therein.

In this heat engine application, the heat exchange will involve 3 parties: the PCM, heating fluid and cooling fluid, but the heating fluid and cooling fluid is not allowed to flow at same time in their respective vessels, and at any given time, only one of the 2 fluids is supposed to exchange heat with the common environing medium PCM. Therefore, herein design must reserve some minimal space between the twined vessels, so as to let the PCM fill the gaps and play forever role in all heat exchange processes.

The sub-FIG. 3A shows view of the cross section that is vertical to cylinder central axial line, and there is a label to indicate the above-said gaps between the 2 spiral-twined vessels.

The sub-FIG. 3B shows the 3-dimensional cut-away view at an informative angle. There are 2 pairs of arrows with different graphic filling patterns, each of which refers to an independent embedded vessel. As zooming out too much, this sub-figure is not convenient to show the existing in-between small gaps.

Description on FIG. 4

FIG. 4 shows a hydraulic rectifier and its electric equivalent circuit.

Of which, the sub-FIG. 4A illustrates a bridge-style hydraulic rectifier that simply comprises 4 hydraulic check valves. The pressurized oil always flows out of the marked port P+, and returns to the port P− without exception, but anyway, the marked bidirectional hydraulic pump can infuse oil in any random direction while the pressure polarity of output hydraulic current can still keep invariant.

In a sense, it is just like as a high fidelity translation of the classical electronic bridge-style rectifier consisted of 4 diodes, and the sub-FIG. 4B just shows the electronic circuit that is equivalent to the fluidic circuit. As it is too classical, perhaps this rectification circuit can be found in all relevant basic textbooks of electronics.

As long as professional peer can understand the simple electronic version rectifier, inspired by analogy, one can automatically understand how the fluidic version rectifier works.

Description on FIG. 5

FIG. 5 shows the masterplan of pressure retarded phase change heat engine & heat pump integrated system.

The root energy comes from the heat fluxing from the heat source to the heat sinker, and both heat reservoirs are conspicuously drawn at the top bar for heat source & bottom bar for heat sinker. This design prefers 2 species of storage-purposed PCM to constitute heat reservoirs, and of course, the melting point T_{H} of the heat source PCM must be greater than T_{L} of the heat sinker PCM. The PCM selection should take many factors into consideration, such as the available heat resource, climate, engineering condition, etc.

The heat source or sinker is abstract concept. In real world, a heat source can be sustained by waste heat, solar heater, woodstove, etc. The top right corner in the figure illustrates an optional biomass boiler which embedded heat exchanger is pipe-connected with its counterpart embedded in the PCM bulk container.

The ideal PCM is supposed to take in or send out large quantity thermal energy without sensible temperature change, but likely with phase change. Non-PCM aggregates can also render the feature of quasi constant temperature without phase change, for example, be can the topsoil of Earth if it is of quasi infinite accessible & heat exchangeable. Thus, an engineered soil block or hillock can mimick the PCM property and replace the expensive PCM heat sinker.

Heat sinkers can also be artificial with cryogenic extreme low temperature, but evaporation will gradually reduce mass. For example, in a grid-scale Liquid Air Energy Storage (LAES) system, the huge tank with load of liquid nitrogen can be used as the heat sinker in this SLHE.

In mid zone of the figure, a pressure transformer with all-through axle style is hooked up to the 2 heat reservoirs and other peripheral parts, and it uses the third different species of PCM as working medium which melting point T_{W} should lie about the mean value of those of heat source & heat sinker, i.e. there is relation: T_{H}<T_{W}<T_{L} or T_{W}≈(T_{H}+T_{L})/2.

It can benefit the system performance that keeping all PCM less-affected by environment.

The heat source and heat sinker usually use large quantity of PCM, for instance, in scale of tons weight. As long as the T_{H} & T_{L} is reasonably determined, the climate or weather may impose less negative effect, but insulating the heat source is always a favorable & encourage-able practice.

If any thermal sensitive component works at very close or equal to atmosphere temperature, then needless of insulation; otherwise good insulation should be in place, e.g. the artificial cryogenic heat sinker is about 200° C. lower than environment, so it must be well insulated.

As to the working medium PCM, fully filling respective cylinders just needs small amount, or is equivalent to a tiny fraction of the backlog in the heat reservoirs. Generally speaking, the less the mass, the lower the heat capacity, then the higher the risk of weather side effect.

Therefore, the portion of PCM chambers of the pressure transformer is better to be wrapped in a niche with air conditioner, but it is not as economic & convenient as simply wrapped in thick insulation material, obviously styrofoam insulation is more practical.

For better control, a sensor is used to report realtime position of reference point on the power axle, so as to properly switch heat transfer path inside the pressure transformer.

In central right of the figure, the hydraulic powertrain accepts power from alternating oil current squeezed by the pressure transformer. It comprises a set of 4 check-valve oil rectifier, hydraulic accumulator, and hydraulic motor that drives electricity generator with the PTO shaft.

An oil tank is drawn underneath the hydraulic motor, and with help of atmosphere pressure, the exhausted oil can be siphoned back to the unpressured oil chamber of the pressure transformer via a check-valve.

There is also a dash line at left of the tank that stands for bypass pipe. It means the tank is not a must-have, but the cheap bypass pipe will sacrifice the conveniences of checking oil quality, degassing and casual replenishment.

The electricity generator maintains auxiliary unit that comprises rechargeable battery and logic controller, as the reciprocal motion of the pressure transformer needs accurate management on all peripheral electromagnetic valves and pumps, so as to convert heat-caused phase change into alternating oil current that carry desirable mechanic energy.

To save auxiliary power, pump's function may be replaced by natural thermal convection with proper mechanic setting to invite gravity assistance, just like as a regular rooftop solar water heater without circulation pump.

As a high end product, the controller can even be embedded with computer & smart software; also possible to embody a low end product with mechanic programmable logic controller, e.g. the old style code-notched disk or cam.

The controller basic functions include realtime data acquisition and switching signals output. The acquired data include but not limited to: reciprocal axle position, oil pressure, hydraulic motor speed, temperatures at different key points.

Assuming the PCM in the pressure transformer expands if heated, i.e. ΔV/ΔT>0, now follow me to see how the controller turning valves & pumps ON & OFF in a full cycle.

First half cycle: valve #1 & pump #6 ON, valve #2 & pump #5 OFF, top PCM chamber is cooled & shrinking; valve #4 & pump #7 ON, valve #3 & pump #8 OFF, bottom PCM chamber is heated & expanding. The common axle moves upwards.

Second half cycle: valve #1 & pump #6 OFF, valve #2 & pump #5 ON, top PCM chamber is heated & expanding; valve #4 & pump #7 OFF, valve #3 & pump #8 ON, bottom PCM chamber is cooled & shrinking. The common axle moves downwards.

In next cycle, above 2 half-cycle will repeat, and keep so on.

Some large heat exchangers are buried in two main heat reservoirs and used to transfer heat between reservoirs and pressure transformer with proper thermal conducting liquid & those auxiliary circulating pumps.

The number of reservoir-side heat exchangers can be variable and dependent on reservoir dimension or engineering conditions, for example, there are 3 drawn in the heat source, but only 1 possible if they share a common one, or no need of external indirect heater.

As to the heat pump in this masterplan figure, it is not the focus of the subject inventions, though drawn herein. Luckily, because the SLHE usually works within a relative smaller temperature range ΔT, this will benefit the heat pump with the hope of higher COP.

By using a mid PCM heat reservoir which temperature is close to the phase change temperature of the working media in the pressure transformer, it is possible to use 2 cascading heat pumps, each works within a half of the heat engine ΔT, and the semiconductor Peltier heat pumps can take this advantage, so as to reach greater COP>2 (some publications claim COP=10 at ΔT=7° C.). Lean size mid PCM heat reservoir is good enough for cascading heat pumps.

Description on FIG. 6

FIG. 6 shows the timing of valves, pumps, assuming the power output is constant.

The SLHE is supposed to work at accurate pace for converting heat of phase change to hydraulic power. The central logic controller is responsible to manage the pace.

The sub-FIG. 6A shows the dynamic position of the common axle with time elapse within a full period, and the “position=0” means the center position while both oil compartments hold same volume. The “1” denotes the max run length of the axle shift between the coordinate valve −L/2 and +L/2.

The position sensor is responsible to timely feedback the central logic controller with current coordinate, so as to regulate heat flux by switching proper valves and pumps. Therefore, the position curve will affect all other signal's curves.

Sub-FIG. 6B shows the status change of the valve #1 #4 and pumps #6 #7: OFF during the first half cycle and ON in the next half cycle.

Sub-FIG. 6C shows the status change of the valve #2 #3 and pumps #5 #8: ON during the first half cycle and OFF in the next half cycle.

In both 6B & 6C, it can be seen that actuations delay somewhat at beginning and early stop before finishing the half cycle, and this adjustment is for adaption of heat inertia.

Sub-FIG. 6D shows the reciprocal velocity of the conjugate driving shaft of the PCM to hydraulic pressure transformer. While the retarded phase change is occurring, the said shaft will gradually move from standstill to a stable velocity, then keep some time span, even the center position is passed in the middleway, until the conjugate pair of PCM chambers simultaneously suspend all connections with external heat source & sinker. By the short period thermal inertia, the shaft shall gradually decelerate, even motion direction is changed at the dead position, until the said PCM chambers pair is recharged with a toggled aka reversal heat flux. In fact, if the power output is not constant, or loads are changing, every single period may display different position-time curve, and valves & pumps states correspond synchronously.

Description on FIG. 7

FIG. 7 shows the pressure curve rendered on the hydraulic motor.

When the hydraulic motor is working hard to output energy onto loads, the oil pressure inside hoses will change, though the associated hydraulic accumulator can smooth the pressure. The pressure curve looks like ripple wave, and minor pressure oscillation usually does not affect the operational stability.

The wave height reflects the pressure drop ΔP, and generally speaking, it is proportional to the loads duty and the retarded PCM temperature difference between melting & freezing points.

During the axle changes reciprocal direction, there is a special moment without thrust force on the oil chambers. Thus, thanks to the smoothing function of hydraulic accumulator, otherwise, the pressure curve will be the sharp drop shape at the transience, as showed in the dotted curve in the figure.

Too big pressure ripple may cause noise or shorten lifetime of the motor. By using enough higher capacity hydraulic accumulator, pressure ripple can be depressed to acceptable level.

Description on FIG. 8

FIG. 8 illustrates a multi-cylinder cascading SLHE. Although only 2 sets of cylinders are drawn in serial link, however, no limit is imposed as long as large enough is the temperature differential between top heat source & bottom heat sinker.

This model can also be referred as multi-stage SLHE, and obviously it is more efficient.

A single cylinder SLHE is always low efficient, as phase change ideally appears with zero temperature change, or small ΔT in retarded condition, and because efficiency of heat engine is proportional to the ΔT, so a ready high ΔT resource is a waste if driving a SLHE, except boosting the power by higher heat transfer rate, but no boost on power efficiency.

By linking multiple cylinders SLHE to high ΔT resource, the total efficiency is also multiplied, because the rejected heat of previous stage can be further utilized as input heat of next stage, and pass on stage to stage, so as to reduce the last rejected heat.

Usually the efficiency is about 5% to 10% for a single cylinder SLHE, depending on the system configuration. With this linkage mode, the greater Carnot efficiency may be approached, though a short distance to the ideal state still exists.

Let the figure be focused now. In the cylinders chain, previous heat sinker functions as heat source of next cylinder block. All cylinder blocks share the same “brain”, i.e. logic controller, and also share a central hydraulic motor & oil tank.

The hydraulic oil tank is a must-have for oil buffering and distribution, because multiple cylinder blocks may not synchronously work with a fixed phase angle, unlike there is exact 120° phase angle in conventional 3-phase electricity power supply.

Constituent cylinder blocks are better to equally divide the whole temperature differential. In the figure, the PCM melting point of top reservoir is marked by T₁, the bottom reservoir by T₃, and the mid shared lean reservoir by T₂. So it is suggested: T₂≈(T₁+T₃)/2, the upper block working PCM melting point (T₁+T₂)/2, the lower block working PCM melting point (T₂+T₃)/2, and the internal nest lean reservoir of each block is optionally deployable for enhancing heat pump's COP, they use same PCM with respective host engine's working PCM.

For example, a 2-cylinder SLHE is designed to work within 100° C. heat source and 0° C. heat sinker, then set a shared lean heat reservoir about 50° C., let first cylinder block work between 50° C. and 100° C., and let second one work between 0° C. and 50° C. As to the working PCM inside pressure transformers, set the first one melting point 75° C. and the second one 25° C.

Just like as the exact equality of max voltage amplitudes in 3-phase hydro lines, the same rule applies to herein secondary pressures aka output pressures of all pressure transformers of entire SLHE powertrain, yet respective primary pressures aka input pressures of PCM expansion can be quite different, as PCM selection is hard to assure the equality of expansion pressures.

By individually setting the area ratio of hydraulic oil piston to PCM piston, the output hydraulic pressure equality can be assured, and it must be done for a workable eventual multi-cylinder system.

As quality PCM is expensive, all unimportant PCM lean reservoirs shall use as less as possible, even could be needless; but the working PCM is very important and it needs not much in a cylinder chamber, hence, always put performance first, and ignore the cost factor.

Such an open architecture of cascading powertrain does encourage apparatus manufacturers to individualize their proprietary PCM recipes or patterns of combinations without departing the essence of subject invention, and any derived proprietary can be kept as respective commercial secret just like as the classical Coca Cola recipe.

Of course, as a polymath scientist and long time researcher in this domain, I have accumulated my own undocumented PCM plus detail thermodynamic data list with broad gamut of melting discrete points covering all 1 Kelvin width slot of temperatures and kaleidoscopic patterns of PCM combinations for multi-cylinder SLHE in variable applications.

Description on FIG. 9

FIG. 9 illustrates the rationale of efficiency amplification of cascading heat engines.

Given efficiency of the 2 engines by η₁η₂, with source heat Q1 inflow, there are following results: work of first engine W₁=η₁Q₁; rejected heat Q₂=Q₁−W₁=(1−η₁)Q₁; work of second engine W₂=η₂Q₂=η₂(1−η₁)Q₁; last rejected heat to sinker Q₃=(1−η₂)Q₂=(1−η₂)(1−η₁)Q₁.

At last, total efficiency η=(W₁+W₂)/Q₁=η₁+η₂−η₁η₂

Because η₁η₂ both less than 1, especially less than 0.1 for SLHE with small temperature drop, thus η₁+η₂>>η₁η₂, then the whole system efficiency is very close to the sum of two engine's efficiency: η≈η₁+η₂

Key temperatures are marked in the figure: T₁ stands for temperature of the heat source, T₃ for heat sinker, and T₂≈(T₁+T₃)/2 for the mid lean heat reservoir.

For generalization & idealization, assuming there are N sets of Carnot heat engines, each takes same temperature drop ΔT, their respective high port temperatures T₁, T₂, . . . , T_{N}, and T₁>T₂> . . . >T_{N}, then total efficiency of the N-chain is ΔT/T₁+ΔT/T₂+ . . . +ΔT/T_{N}>NΔT/T₁.

If using one ideal Carnot heat engine to replace the N-chain, then its efficiency is just NΔT/T₁.

Therefore, in mathematic sense, cascading enough SLHE can jailbreak the supreme Carnot efficiency; but in physic sense, it is hopeless.

As the entire temperature drop is fixed, the more the cascading engines, the less the allocated temperature drop for individual engines, and the longer the heat exchange time, or the more cumbersome the heat exchanger, so that will undermine available output power or economy.

For the best practice, by a trade-off, it is encouraged to use a reasonable plurality of cylinder blocks SLHE, so as to achieve 50% to 80% of the ideal Carnot efficiency.

In a sense, multiple cylinders SLHE, is analogous to the multiple cylinders ICE (Internal Combustion Engine), though the former can be more efficient. The efficiency of a ICE is about 30%, nonetheless theoretical Carnot efficiency should be about 70% at 800° C. temperature drop; in contrast, by linking circa 4 SLHE, the ensemble may reach same efficiency 30% at about 150° C. temperature drop.

Because of simplicity, the powertrain of multiple cylinders SLHE is not difficult to realize. A car engine can have 4 to 8 cylinders, why hesitate to use 2 or more cylinders SLHE harmoniously? In fact, the key challenge is how to configure & outsource all PCM with different melting points.

### Tips and Exemplar Embodiments of Favorable Apparatus

How to Select PCM for Main Heat Reservoirs?

It highly depends on application.

Usually there is minor differential between PCM melting point and freezing point, though identical for ideal PCM, and the smallest differential is preferred.

Phase change will inevitably cause density change, and the smaller change is preferred, because most heat reservoirs are sealed airtight to keep mass constant, and large change rate of volume may rupture containers. Good thermal conductivity is also important, thus some suppliers may sell copper-foam filled PCM or pallets or capsules with tailored radiative properties. Engineering jobs may be needed for container and submersion of all necessary heat exchangers.

Make sure to order enough quantity to match project size, as PCM quantity of usage depends on power rating, energy density and melting point, thus consideration should be given to the balance of performance, price and other engineering conditions.

For stationary projects, storage energy density may count for little, even the dirty cheap but low energy density sulfur aggregates can be selected; but for mobile applications, e.g. powering a car, the highest energy density is desperately preferred so as to reduce the dead weight and to prolong the specific mileage per full recharge.

As to the melting point selection, just let it be commensurate to the heating sources. For example, if the industrial waste heat is used, then it is OK to set PCM melting point about 50° C.; else if the evacuated tubes solar collector, then 80 to 100° C.; else if the focused parabolic-mirror troughs, then 300 to 550° C.

As this class of storage-purposed PCM demands large staple supply, thus many publications often mention those most economic PCM list. But following 2 classes of PCM could need special consultant with specialists, and applications are usually not sensitive to their price, but sensitive to physic properties, because of small usage in cylinders. A basic rule is to avoid toxic materials.

How to Select PCM for Intermediate Heat Buffers?

Multi-cylinder SLHE may need a series of intermediate heat buffers, so as to reduce the amplitude of temperature rise & fall in the boundaries of neighboring cylinder blocks.

The selection criteria are less strict for these heat buffers. The masses are far less than the main heat reservoirs, even as less as those working PCM, or just eliminate if neighboring cylinder's working PCM have similar latent heat performance.

How to Select the Working PCM?

Those working PCM are assumed to fill all PCM cylindrical chambers of PCM-hydraulic pressure transformers, and volumes are far less than the main heat reservoir.

Most selection criteria are same with the heat reservoirs, just with minor exceptions. The important exception is that a higher volumetric change is preferred during phase change, because it matters to the conversable and harvestable energy.

Usually 10% volume change rate ΔV/V is acceptable, e.g. water, and the higher the volume change, the better the performance. Some PCM can even go up to 20%, such as lard oil, though it may be not good enough because of its other demerits.

In general, the lower volume change means higher expansion pressure, even too high to safely contain it, that is one of the reasons for choosing higher volume change PCM. The optimal pressure is about the same level with commercial hydraulic products, i.e. 300 to 500 atm, despite the reluctantly acceptable highest pressure may be 3000 atm by a super duty setting of 1+ inch thick steel wall of cylinders.

To get phase change pressure, a temperature-pressure phase diagram is needed, but only a few of common PCM have the said diagrams. Even a phase diagram is not enough, because the volume change parameter may need other data sheet to provide, unless the well-known common sense 10% of water.

For the unknown volume change rate, it can be easily determined by experiment, as long as a sample accessible, but for phase change pressure, experiment calibration may be complicated and too expensive.

Hereby, I offer an empirical equation to estimate the phase change pressure.

Pre-Calculating:

K₁=ratio of vapor to liquid volume at boiling point; K₂=ratio of evaporation to fusion enthalpy; K₃=solid-liquid phase change rate ΔV/V. Of which, K₁ and K₂ need to look up thermodynamic data sheet.

Based on above intermediate results, the phase change pressure ≈K₁/(K₂K₃), unit: atm.

As to how the equation is deduced, here is not the place to write lengthy scientific paper, however, my future publication will discuss this matter, so if peers interested, welcome to check the preprints deposit of my scholar papers at http://vixra.org/author/yanming_wei.

Example #1: water's K₃=10%=0.1 at melting point 0° C.; K₁=1696 at boiling point 100° C.; K₂=6.4; thus water to ice phase change pressure=1696/(6.4*0.1)=2650 atm. As per the phase diagram of water, its accuracy looks pretty good.

Example #2: sulfur's K₃=0.1 at melting point 115° C.; K₁=420 at boiling point 445° C.; K₂=26; thus its phase change pressure=420/2.6=161 atm. By the way, this pressure does not make best use of hydraulic oil, but it can be overcome by designing smaller area of hydraulic side piston than PCM side piston in the PCM to hydraulic pressure transformer.

Limiting Piston's Velocity by Reasonable Cylinder Geometry Profile

Supposedly hydraulic cylinders ram speed should be less than 25 cm/s, and the lesser the speed, the lower wearing as well as longer life expectation a cylinder will be.

The output power equals to the product of pressure and volumetric flux rate. As long as the working PCM and heat flux are both determined, PCM volume change rate ΔV/Δt can be fixed, then divided by max ram speed, the minimal piston area is solved, and further dividing the PCM chamber volume by the solved piston area, the max length or height of PCM chamber is found.

Design example: given 1,000 watt aka 1 kw heat engine capacity, 1 liter working PCM, 2 liter submersible heat exchanger, phase change pressure 500 atm, then ΔV/Δt=20 ml/s=20 cc/s, minimal piston area=20/25=0.8 cm². If using 100 cm² piston, then PCM chamber length=3000/100=30 cm, and piston velocity=20/100=0.2 cm/s=2 mm/s, it implies a great service factor 25/0.2=125, thus, never worry about the piston wearing.

In contrast, a regular heat engine can be usually seen about 2000 RPM flywheel dizzy rotation with unwanted but inevitable loud noise; pleasantly, SLHE pressure transformer ram reciprocal velocity may be seen hardly as slow as 2 mm/s, similar to the creep of a silent snail, even so equivalent RPM can spin by subsequent hydraulic motor in the fluid powertrain terminal.

Improvement Options for Anti-Leakage, Anti-Corrosion and Anti-Friction

For a standard hydraulic application, there are no such these issues, but PCM is never intended as hydraulic fluid. However if always firmly follow all established standards and circumvent whatever engineering taboo, then the subject inventions will never debut.

Although toleration for taboos will compromise performance, anyway, a trade-off has to be accepted, in order to achieve otherwise unattainable application.

Inspired by Trump's book “the art of deal”, I audaciously make technical trade-off to combine but isolate standard hydraulic oil and PCM in a hydraulic ensemble, despite minor existence of PCM leakage, corrosion and excessive friction, which are caused by the non-ideal viscosity & fluidity.

To reduce friction on cylinder walls, an improvement method can be optionally used by coating or inserting a liner made of polytetrafluoroethylene aka Teflon, and simultaneously it can fix corrosion problem, because Teflon is chemical inactive to most substances.

As to minor leakage, there are many ways to fix. Of whatever means, using proper sealant gaskets is very important.

The other choice is to select proper working PCM if possible: for same or similar melting point, preference is given to which viscosity is close to SAE-10W or ISO-46 or similar to the hydraulic oil used in other end of the pressure transformer ensemble.

If the working PCM is cheap and eco-friendly, minor leakage may be not worthwhile to fix.

Just like change motor oil, scheduling a good maintenance plan is necessary on the working PCM and peripheral parts.

Nomenclature Tips

As to the name handle of this exotic method & apparatus, there is a full descriptive phrase: solid-liquid phase change cycle & heat engine with optional but highly recommended multiple cylinders cascading powertrain.

Obviously it sounds too chatty and inconvenient, and for an unpopular invention, above chatty name may be acceptable, but for this breakthrough invention, with great popularity in prospect of applications, a short name or appellation is desperately needed.

As the inventor, I suggest to use a formal appellation: Wei engine.

Because this invention is innovated with some inspiration from Trump's book, and his phase change or face change is tremendously powerful in the universe, therefore, Wei-Trump Engine could be also a felicitous choice.

Before its international recognition, I just modestly recuse my suggested proper noun. Instead of immediate usage, I still call it SLHE in short form abbreviation.

### Embodiment Example 1: A Heat Engine as Counterpart of Liquid Air Energy Storage

According to the formula of Carnot efficiency, the lower the temperature of heat source and the larger the temperature drop from source to sinker, then the higher the efficiency will be.

The omnipresent air will liquefy at cryogenic temperature −196° C., i.e. the boiling point of liquid nitrogen. Therefore, if let the liquid air be the heat sinker and ambient normal atmosphere or the approx equivalence be the heat source, then the ideal Carnot efficiency will be circa (20+196)/(273+20)=74%.

With the technology advancement in energy storage, the liquid air energy storage system is gradually looming prospective. Although liquefaction technology is just of old school, however the counterpart, i.e. cryogenic heat engine is still not mature.

The subject inventions just bring great hope for the most wanted technology breakthrough.

By using a multi-cylinder SLHE, the practical efficiency shall jump to 30% to 50%.

Assuming SLHE with 6 sets of cylinder blocks, every set of cylinder will cope with same (20+196)/4=54° C. temperature drop, and the system needs total 4 different working PCM.

The 1^{st} set of cylinder works across 20 to −34° C. with PCM melting point (20−34)/2=−7° C.; the 2^{nd} across −34 to −88° C. with PCM melting point −61° C.; the 3^{rd} across −88 to −142° C. with PCM melting point −115° C.; the last across −142 to −196° C. with PCM melting point −169° C.

It is not easy job to pinpoint all above 4 different PCM, but with a loose attitude to melting points, then there are more choices to determine PCM. For example, if hard to find the PCM in market for the 1^{st} set of cylinder with exact melting point −7° C., then it is also acceptable to select anyone with melting point from −5 to −9° C. range.

Needless to worry about the sign of ΔV/V of PCM, even negative ΔV/V PCM can coexist with positive ΔV/V PCM in the powertrain.

### Embodiment Example 2: Heat Engines for Vehicles

Energy density is vital to a cleantech powered car, and currently the lithium ions battery technology is dominating the market.

Hereby I propose a new type of car power system: it also uses lithium element, but nothing to do with electrochemistry, instead, it is just a special heat engine with lithium-contained PCM thermal storage, can optionally hybridize with onboard external combustion heater or stove as a means of on-demand partial recharge.

Not all PCM created equal, experimental physicists find that: only those compounds with lithium element render superior energy density.

The current known best PCM choice: 20% LiF (Lithium Fluoride)+80% LiOH (Lithium Hydroxide), with 427° C. melting point and 1163 kj/kg or 323 wh/kg heat of fusion, i.e. the latent heat or the thermal energy density. The latent heat is equivalent to the sensible heat of about ΔT=580° C. temperature change of a regular matter with average 2 kj/kg specific heat capacity.

Herein ideal Carnot efficiency is about 57%, and usually a well-designed multi-cylinder SLHE powertrain can run at least a half of the Carnot efficiency, i.e. probably >30% real efficiency for 4-cylinder design, and circa 50% for 8-cylinder design. It renders appreciable 160 wh/kg kinetic energy density at this application.

Above estimation is deduced under assumption that the PCM works only at the narrow range of temperature between melting point and freezing point. In fact, even the PCM has solidified, yet the heat engine can still work, until its temperature too low to sustain.

It is well known that a lithium-ion battery can have a specific energy 100 to 265 wh/kg, therefore, compared with an upper class lithium battery, the new lithium-based heat engine can attain similar kinetic energy density, and then similar mileage performance.

As such a full recharged power pack is very hot at PCM melting point 427° C., the insulation should be good enough for decent shelf life or long rest time, otherwise, it will naturally cool down too fast at an undesirable rate.

Loading an onboard heater is a good means to compensate insulation loss, or to delay even skip the off-board recharge or exchange. The heater fuel can be almost anything, e.g. raw biomass, propane, gasoline, diesel, coal, cab- or trailer-roof solar evacuated heat pipe, etc.

Because the heat to power efficiency can be higher than regular internal combustion engines, the mileage of this engine shall be higher than traditional engine for same fuel, despite it may look ugly herein.

Now, assuming weather temperature 27° C. and SLHE with 4 sets of cylinders, then every set of cylinder will cope with same (427-27)/4=100° C. temperature drop, and the system needs total 4 different working PCM.

The 1^{st} set of cylinder works across 427 to 327° C. with PCM melting point (427+327)/2=377° C.; the 2^{nd} across 327 to 227° C. with PCM melting point 277° C.; the 3^{rd} across 227 to 117° C. with PCM melting point 177° C.; the last across 117 to 27° C. with melting point 77° C.

The remaining work is to select proper working PCM for all constituent cylinders, according to above allocation results.

As to the bottommost heat sinker, the heritage of internal combustion engines can still be used, i.e. water based coolant+radiator+fan for sinking the rejected heat to atmosphere.

Because a well designed multi-cylinder SLHE can have at least equal or higher efficiency with a traditional 4-stroke fossil motor, therefore the rejected heat flux is also in similar quantity, thus the radiator can be similar size & capacity. The efficiency of 8-cylinder SLHE can even very close to the ideal Carnot efficiency, therefore its radiator size will be significantly smaller than an internal combustion engine's.

As to the thermostat, it is mainly supposed to control fan for keeping coolant cool enough, especially in idling or low gear status. When a vehicle runs fast, the radiator will quickly dissipate heat, even thermostat not to turn on the fan behind radiator.

There are many ways to recharge the PCM melting salt tank/cartridge/thermo, such as electric heating, concentrated-solar heating, offboardly/onboardly hooking its heat exchanger with a wood/coal/biomass furnace.

In future, commercial thermo exchange stations network can be quickly established, because of its dirty cheap infrastructure with whatever flexible easy heating methods, then exchange service can be done fast for drivers & recharge jobs can be done in backstage.

The braking energy reclamation can be easily integrated with this powertrain, because these two parties can share the same hydraulic accumulator and other hydraulic components; but pure electric vehicles are impossible to implement so. This way can save lots of energy!

### Embodiment Example 3: Heat Engines for NetZero Residences

A zero-energy building, also known as a zero net energy (ZNE) building, net-zero energy building (NZEB), or net zero building, is a building with zero net energy consumption, meaning the total energy amount used by the building on annual basis equals roughly the amount of renewable energy created in situ, or in other definitions by renewable energy sources elsewhere.

Although photovoltaic panels are most preferable in NZEB at current technology level, its intermittence makes the system not perfect, if not combined with decent energy storage.

PCM is good media for thermal energy storage, but unfortunately it is a blank market for regular family affordable organic Rankine heat engines.

The subject invention can well address this application by a powertrain of multi-cylinder cascading SLHE to cope with a mediocre temperature drop that is usually under 200° C.

Setting too high temperature drop will beyond the capability of all available unconcentrated solar flat collectors in market, though it will benefit to efficiency.

Currently the low cost flat solar collectors with honeycomb design can heat up to 250° C., e.g. the market available Israeli Tigisolar brand. Therefore, the PCM melting point is better under 200° C. for the thermal storage.

The reachable max temperature for solar collectors will not compromise much even in high latitude cold zones, but the average temperatures have big change in different seasons, and in winter, it may be 50° C. lower than summer. This will affect the efficiency of heat engines in year-round period.

Usually, the temperature of heat sinker is about the same with the daily weather, but it can be stabilized somewhat if it is buried underneath for certain depth.

As it is a stationary application, hence, the PCM energy density is no longer importance, and cost becomes a key factor.

Design instance: PCM storage uses the cheapest sulfur aggregates, about $100/ton, melting point 115° C., weather 0° C. is the heat sinker temperature.

Two cylinders SLHE can work at 15% to % 20 efficiency: the 1^{st} set of cylinder works across 115 to 55° C. with PCM melting point (115+55)/2=85° C.; the 2^{nd} across 55 to 0° C. with PCM melting point 27° C.

Fusion heat of sulfur, aka thermal density of sulfur is about 54 kj/kg or 54 Mj/ton or 15 kwh/ton. If efficiency=15% and daily electricity demand is about 10 kwh for a family, then the required thermal storage=10/0.15=67 kwh, or 67/15=4.5 tons sulfur. Given specific weigh 2 ton/m³, total storage volume at least 4.5/2=2.25 cubic meters.

Of course, workable NZEB should also equip heat pumps to synergize the entire system with solar energy & heat engines. Heat engines are for discharging energy; as the counterpart, heat pumps & solar collectors are both for recharging energy, yet heat pumps recharge to both heat source and sinker, but solar collectors recharge only heat source.

### REFERENCE

1. Cryogenic engines, by Ding et al, US20090320476A1
2. Phase change heat engine, by Gray et al, U.S. Pat. No. 6,186,126
3. Heat engine for converting heat energy into mechanical energy which is used to generate electricity, by Nickel Werner, Germany patent DE202010008126U1
4. New database on phase change materials for thermal energy storage in buildings to help PCM selection, by Barreneche et al, DOI: 10.1016/j.egypro.2014.10.249

All inventions herein contain key implementing methods and preferred embodiments, and may be flexibly embodied in other specific forms or consisted of different geometry or other configurations without departing from its spirit or essential characteristics.

In all methods and derived apparatuses, the working medium is always of the kind of solid-liquid Phase Change Materials, abbreviated as PCM. Generally speaking, PCM cannot always be regarded as fluid in large scale motion, but in the small scale peristaltic-like motion during phase change, assuming fluidity is reasonable even in the transient quasi solid state.

For concise description, abbreviations AC & DC are also used to stand for Alternating Current and Direct Current respectively.

1. A method to run heat engine by periodically changing phase of the working PCM between solid and liquid via properly regulated heat influx and outflux through two conjugated PCM chambers, and in anytime, the systematic heat flow is always from heat source to heat sinker;

2. In addition to claim 1, further convert the linear motion of PCM expansion & contraction into the imitative motion of hydraulic oil in two conjugated chambers by co-axle or joint-axle reciprocal drive but different push area possible so as to cause pressure upscale or downscale;

3. In addition to claim 1, subsequently convert the AC hydraulic oil flow to DC hydraulic oil flow so as to drive a regular hydraulic motor for torque output or whatever purpose;

4. In addition to claim 1, use a central logic controller to take care of all above processes, and some sensors should be used for feedback of data & status, such as position, speed, temperature, so as to enable proper actuations on electromagnetic valves, pumps, etc.

5. A basic apparatus of heat engine that is built by use of the claim 1 method. It comprises a pressure transformer that contains PCM-soaked heat exchangers and converts the working PCM motion to hydraulic oil motion, a set of fluidic AC-DC rectifier, hydraulic accumulator(s), a hydraulic motor, all necessary connection hoses, and a central logic controller; the said basic apparatus can be deployed as constituent unit, so as to cascade a plurality of units in serial powertrain for purpose of efficiency multiplication.

6. In addition to claim 5, in cascade mode, all units should equalize their output hydraulic pressure, so as to workably balance their input thermal flux; and should also share both the central hydraulic motor & the central logic controller, so as to reduce the complexity and cost of the entire heat engine.

7. An automotive vehicle that is powered by rechargeable thermal storage, its engine can be any workable heat engine, however, multi-cylinder SLHE is highly recommended because of the highest possible efficiency.
